(19) United States
(12) Patent Application Publication
(10) Pub. No.: US 2017/0277362 A1
(43) Pub. Date: Sep. 28, 2017

(54) METHOD AND ELECTRONIC DEVICE FOR CONTROLLING FOCUS BOX

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Long LI, Beijing (CN)

(21) Appl. No.: 15/245,614

(22) Filed: Aug. 24, 2016

Related U.S. Application Data
(63) Continuation of application No. PCT/CN2016/089323, filed on Jul. 8, 2016.

(30) Foreign Application Priority Data
Mar. 22, 2016 (CN) 201610166662.5

(51) Int. Cl. G06F 3/0481; G06F 3/0485; H04N 5/44; G06F 3/0489

(52) U.S. Cl. CPC G06F 3/0481; G06F 3/0489; G06F 3/0485; H04N 5/4403

(57) ABSTRACT

A method for controlling a focus box is provided. The method includes: at an electronic device, monitoring slide events of a recycler view; freezing the focus box in a current position when monitoring a beginning of slide of the recycler view; calculating an item of the recycler view corresponding to the current position of the focus box when monitoring an end of the slide; and setting the item of the recycler view in the position covered by the focus box such that the item covered by the focus box obtains a focus.

### CROSS REFERENCE TO RELATED APPLICATIONS

The present disclosure is a continuation application of PCT International patent application No. PCT/CN2016/089323, filed on Jul. 8, 2016, which claims priority to Chinese Patent Application No. 201610166662.5, filed with the Chinese Patent Office on Mar. 22, 2016, both of which are herein incorporated by reference in their entireties.

### TECHNICAL FIELD

The present disclosure relates to the technical field of multimedia, in particularly, to a method and an electronic device for controlling a focus box.

### BACKGROUND

An Android UI system operating on a television platform takes controls as basic display units. Each control has one attribute: focus, and two states: with or without focus. Controls with focus are the same as those without focus in appearance by default. In order to indicate which control has a focus at present, a focus box is required to display to a user. Therefore, when the focus is transferred, the focus box must appear as soon as possible on the control newly obtaining the focus.

An Android slide control RecyclerView in the Android UI system can easily realize one-dimensional and two-dimensional list layout, set spacing between cellintervals, make focus transferring rules, etc. However, when a focus box selecting key is pressed continuously or pressed fast and continually, a phenomenon of losing a focus box possibly occurs. For example, two fixed controls A and B exist in the upper left corner of a screen shown in FIG. 1, and a one-dimensional RecyclerView control exists below, wherein first to fourth items are displayed on the screen. In fact, there are fifth, sixth, seventh or even more items outside the screen. At the moment, the focus and the focus box are on the fourth item. Once the user presses a focus box rightward selecting key, the list is about to slide into the fifth item. Meanwhile, the AndroidUI system receives a key pressing event. Immediately, the fourth item loses the focus, and then a search for a control that should receive the focus begins. Although the fifth item is still outside the screen, it is closest to the fourth one in the key pressing direction. Thus, the RecyclerView takes two actions: (1) sliding the fifth item into the screen, and (2) giving the fifth item the focus. Every time the AndroidUI system receives one key pressing event, the item owning the focus at present will lose the focus, then search for a proper control is performed to receive the focus. Moreover, the RecyclerView only caches the closest item outside the screen, and items farther away from the screen are not within its cache range. Therefore, when the user presses the key fast or directly presses the key and holds it down, the AndroidUI system receives a number of key pressing events one after one in short intervals. When the AndroidUI system receives the first key pressing event, it slides the fifth item into the screen and makes the fifth item obtain the focus. Despite the fifth item obtains the focus rapidly, it slides too slowly to enter the screen completely. Since the user is still pressing the key, the second key pressing event has been transferring at the same time. As the fifth item does not slide to the due position, the sixth item does not enter the cache range of RecyclerView. The Android UI system deprives the fifth item of the focus and searches for the closest control on the right of the fifth item, but this control does not exist at all (the sixth item does not enter the cache range). According to the focus transferring rules of the Android UI system, the control A on the upper left corner of the screen obtains the focus. If the focus box rightward selecting key is continuously pressed, the fifth item slides into the screen. Subsequently, the focus and the focus box are both transferred to the A control, and then to the control B, so the focus box does not move according to the user's needs.

### SUMMARY

A method for controlling a focus box is provided in an embodiment of the present disclosure. The method includes: at an electronic device, monitoring slide events of a recycler view; freezing the focus box in a current position when monitoring a beginning of slide of the recycler view; calculating an item of the recycler view corresponding to the current position of the focus box when monitoring an end of the slide; and setting the item of the recycler view in the position covered by the focus box such that the item covered by the focus box obtains a focus.

An electronic device is provided in another embodiment of the present disclosure. The electronic device includes at least one processor and a memory communicably connected with the at least one processor for storing instructions executable by the at least one processor, wherein execution of the instructions by the at least one processor causes the at least one processor to:

monitor slide events of a recycler view;

freeze the focus box in a current position when monitoring a beginning of slide of the recycler view;

calculate an item of the recycler view corresponding to the current position of the focus box when monitoring an end of the slide; and

set the item of the recycler view in the position covered by the focus box such that the item covered by the focus box obtains a focus.

A non-transitory computer-readable storage medium is provided in still another embodiment of the present disclosure. The non-transitory computer-readable storage medium stores executable instructions, wherein when executed by an electronic device, causes the electronic device to:

monitor slide events of a recycler view;

freeze the focus box in a current position when monitoring a beginning of slide of the recycler view;

calculate an item of the recycler view corresponding to the current position of the focus box when monitoring an end of the slide; and

set the item of the recycler view in the position covered by the focus box such that the item covered by the focus box obtains a focus.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a focus box of a recycler view of an Android TV system in the related art;

FIG. 2 is a schematic diagram of a focus box provided by the present disclosure;

FIG. 3 is a flowchart of an embodiment of a method for controlling a focus box provided by the present disclosure;

FIG. 4 is a flowchart of another embodiment of a method for controlling a focus box provided by the present disclosure;

FIG. 5 is a schematic diagram of an embodiment of an apparatus for controlling a focus box provided by the present disclosure;

FIG. 6 is a schematic diagram of another embodiment of an apparatus for controlling a focus box provided by the present disclosure; and

FIG. 7 is a schematic diagram of an embodiment of a smart terminal provided by the present disclosure.

### DETAILED DESCRIPTION

In order to make the objective, technical solution and advantages of the present disclosure more clearly understood, the present disclosure is further explained in details by combining with embodiments with reference to the drawings.

It should be noted that all the expressions “first” and “second” in the embodiments of the present disclosure are intended to differentiate two non-identical entities with an identical name or two non-identical parameters with an identical name. As can be seen, “first” and “second” are only for the convenience of expression, and should not be understood as limitations to the embodiments of the present disclosure, which will not be explained again in the subsequent embodiments.

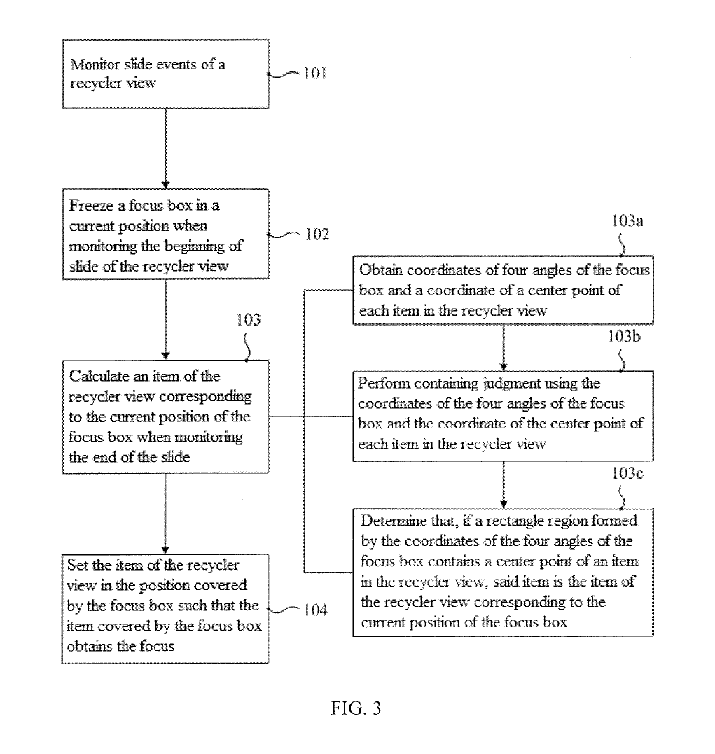

As shown in FIG. 3, a method for controlling a focus box is provided by an embodiment of the present disclosure. The method includes:

In Step 101: monitoring slide events, including beginning and end of slide, of a recycler view;

Wherein a monitoring module can be set to monitor the slide events of the recycler view in specific applications;

In Step 102: freezing a focus box in a current position when monitoring the beginning of the slide of the recycler view;

In Step 103: calculating an item of the recycler view corresponding to the current position of the focus box when monitoring the end of the slide;

In Step 104: setting the item of the recycler view in the position covered by the focus box such that the item covered by the focus box obtains the focus.

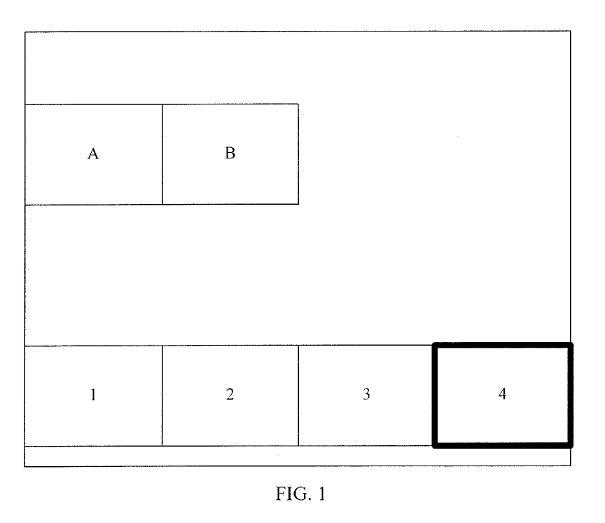

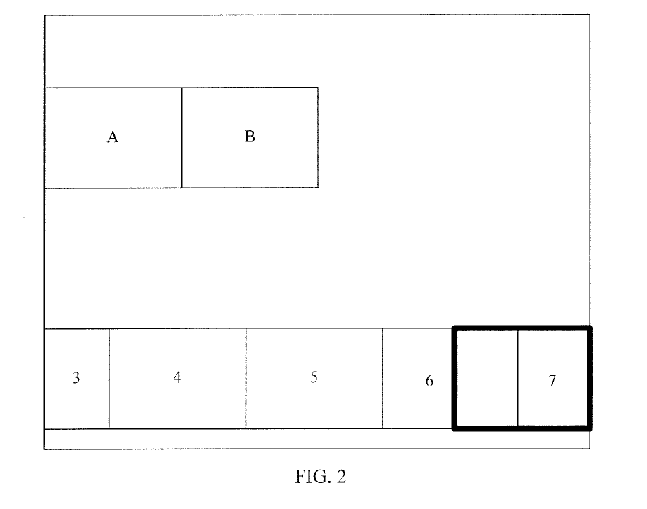

In some exemplary embodiments, a monitoring module is set; the focus box has moved to the edge of a screen (on an item 4 shown in FIG. 1); a user presses a rightward selecting key and intends to select other items such as items 5, 6 and 7 (as shown in FIG. 2) in the recycler view; in this case, after the monitoring module monitors the beginning of the slide of the recycler view, the system freezes the focus box in a current position; since the focus box is set on the upper layer of the recycler view, the recycler view continues to move; when the user releases the key, the recycler view stops sliding, and calculates the item number under the focus box, for example, the sixth item, according to the position of the focus box, and sets the item 6 of the recycler view in the position covered by the focus box such that the item 6 obtains the focus.

In other words, after the focus is transferred according to the existing focus transferring rules (the focus is transferred to the fifth item from the fourth item of the recycler view, and then to the fixed list items A and B when the rightward sliding key is continuously pressed), the focus is transferred once again to a control at which the focus should arrive (the calculated item of the recycler view corresponding to the current position of the focus box) according to a specific service scenario (for example, the recycler view continues to move); in actual use, the focus box stores the position information of the item that should obtain the focus after sliding; afterward, the focus is correctly recovered according to the information, and the wrong focus search result is given up; the final result that the focus box and the focus are on the same item is obtained, and misplacement and loss of the focus box are avoided.

Further, the step of calculating an item of the recycler view corresponding to the current position of the focus box in Step 103 includes:

In Step 103a: obtaining coordinates of four angles of the focus box and a coordinate of a center point of each item in the recycler view;

In Step 103b: performing containing judgment using the coordinates of the four angles of the focus box and the coordinate of the center point of each item in the recycler view; and

In Step 103c: determining that, if a rectangle region formed by the coordinates of the four angles of the focus box contains the center point of an item in the recycler view, the item is the item of the recycler view corresponding to the current position of the focus box.

The coordinates of the four angles of the focus box are defined as (a, i), (a, j), (b, i), (b, j), and the coordinates of the center points of the items in the recycler view are defined as (x1, y1), (x2, y2), (x3, y3), (x4, y4), (x5, y5), (x6, y6) . . . ; take a center point (x3, y3) of one of the items in the recycler view for example, when x3ε(a, b) and y3ε(i, j), the rectangle region formed by the coordinates of the four angles of the focus box contains the center point (x3, y3) of one of the items in the recycler view, and it is determined that the item, the coordinate of the center point of which is (x3, y3), is the item of the recycler view corresponding to the current position of the focus box.

The size of the focus box is the same as that of an individual item of the recycler view. When the user releases the rightward selecting key, the recycler view stops sliding. The item of the recycler view displayed below the focus box may be some complete item or parts of two adjacent items. In the manner of performing containing judgment using the coordinates of the four angles of the focus box and the coordinate of the center point of each item in the recycler view, the item with the center point in the focus box is selected as the item corresponding to the current position of the focus box. Wrong selection of the focus when some contents of the two items are displayed in the focus box at the same time is avoided, and the item corresponding to the focus box is correctly selected.

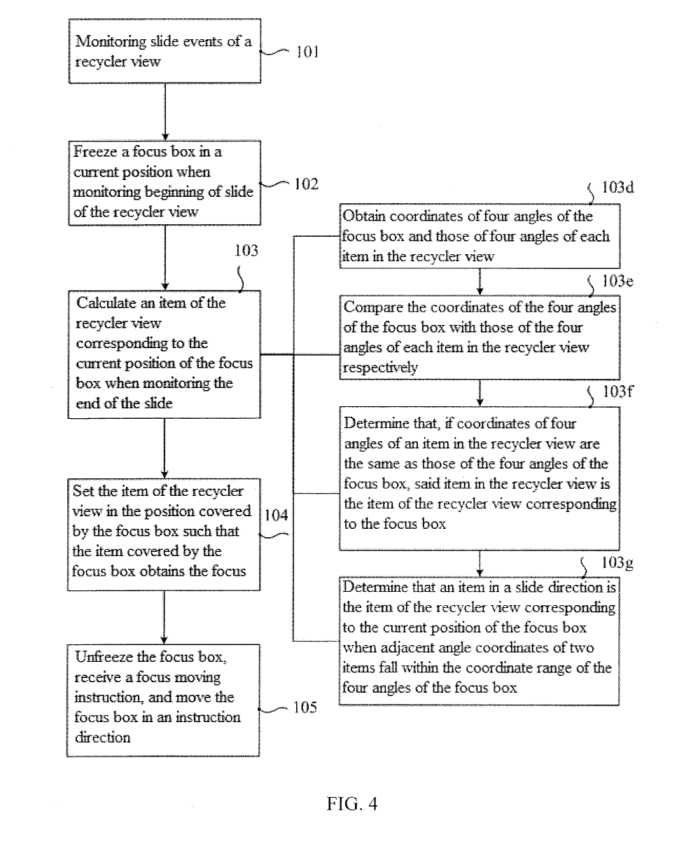

In some exemplary embodiments, the step of calculating an item of the recycler view corresponding to the current position of the focus box in the step 103 as shown in FIG. 4 includes:

In Step 103d: obtaining coordinates of four angles of the focus box and those of four angles of each item in the recycler view;

In Step 103e: comparing the coordinates of the four angles of the focus box with those of the four angles of each item in the recycler view respectively;

In Step 103f: determining that, if coordinates of four angles of an item in the recycler view are the same as those of the four angles of the focus box (the focus box displays some complete item), the item in the recycler view is the item of the recycler view corresponding to the focus box; and

In Step 103g: determining that an item in a slide direction is the item of the recycler view corresponding to the current position of the focus box when adjacent angle coordinates of two items simultaneously fall within the coordinate range of the four angles of the focus box.

After the item corresponding to the focus box is determined, the corresponding item in the recycler view is placed in the position covered by the focus box such that the item covered by the focus box obtains the focus. For example, as shown in FIG. 2, the recycler view slides left; when it stops sliding, two adjacent items 6 and 7 are displayed below the focus box; if it is calculated that the item of the recycler view corresponding to the current position of the focus box is item 6, the recycler view is required to slide right such that the item 6 completely enters the coverage of the focus box; at this point, blocking emerges visually, affecting the visual perception of the user.

The coordinates of the four angles of the focus box are compared with those of four angles of each item in the recycler view respectively. When adjacent angle coordinates of two items simultaneously fall within the coordinate range of the four angles of the focus box (the focus box displays partially two adjacent items 6 and 7). It is determined that an item in a slide direction is the item of the recycler view corresponding to the current position of the focus box, thereby improving visual smoothness and enhancing user experience.

Further, after the focus is obtained in Step 104, the method further includes:

In Step 105: unfreezing the focus box, receiving a focus moving instruction, and moving the focus box in an instruction direction.

In some exemplary embodiments, freezing a focus box in a current position includes: disconnecting focus monitoring of the focus box and keeping the position of the focus box unchanged; and unfreezing the focus box includes: reconnecting the focus monitoring of the focus box and canceling the operation of keeping the position of the focus box unchanged.

According to the method for controlling a focus box provided by the embodiments of the present disclosure, a monitoring module is provided; after the monitoring module monitors the beginning of the slide of the recycler view, the system freezes the focus box in the current position; after the user releases the key and the monitoring module monitors the end of the slide of the recycler view, the item of the recycler view under the focus box is calculated according to the position of the focus box; the item is set in the position covered by the focus box to obtain the focus; the final result that the focus box and the focus are on the same item is obtained; the problem that the focus box is misplaced and the item newly sliding into the screen accidentally loses the focus when keeping on pressing the focus box selecting key is solved in a simple and effective way.

Taking an Android system for an example, a method for controlling a focus box provided by an embodiment of the present disclosure is applied to an Android TV system and includes:

In Step 101: monitoring slide events, including beginning and end of sliding, of a RecyclerView;

wherein a monitoring module can be set to monitor the slide events of the RecyclerView in specific application;

In Step 102: freezing a focus box in a current position when monitoring the beginning of the slide of the RecyclerView;

wherein the step of freezing a focus box in a current position includes: monitoring a focus of the focus box and keeping the position of the focus box unchanged;

In Step 103: calculating an item of the RecyclerView corresponding to the current position of the focus box when monitoring the end of the slide;

wherein the step of calculating an item of the RecyclerView corresponding to the current position of the focus box includes:

In Step 103a: obtaining coordinates of four angles of the focus box and a coordinate of a center point of each item in the RecyclerView;

In Step 103b: performing containing judgment using the coordinates of the four angles of the focus box and the coordinate of the center point of each item in the RecyclerView; and

In Step 103c: determining that, if a rectangle region formed by the coordinates of the four angles of the focus box contains the center point of an item in the RecyclerView, the item is the item of the RecyclerView corresponding to the current position of the focus box;

wherein the coordinates of the four angles of the focus box are defined as (a, i) (a, j) (b, i) (b, j) and the coordinates of the center points of the items in the RecyclerView are defined as (x1, y1) (x2, y2) (x3, y3) (x4, y4) (x5, y5) (x6, y6) . . . ; take a center point (x3, y3) of one of the items in the recycler view for example, when x3ε(a, b) and y3ε(i, j), the rectangle region formed by the coordinates of the four angles of the focus box contains the center point (x3, y3) of one of the items in the recycler view, and it is determined that the item, the coordinate of the center point of which is (x3, y3), is the item of the recycler view corresponding to the current position of the focus box;

In Step 104: setting the item of the RecyclerView in the position covered by the focus box such that the item covered by the focus box obtains the focus.

The method further includes:

In Step 105: unfreezing the focus box, receiving a focus moving instruction, and moving the focus box in an instruction direction; and

wherein the step of unfreezing the focus box includes: reconnecting the focus monitoring of the focus box and canceling the operation of keeping the position of the focus box unchanged.

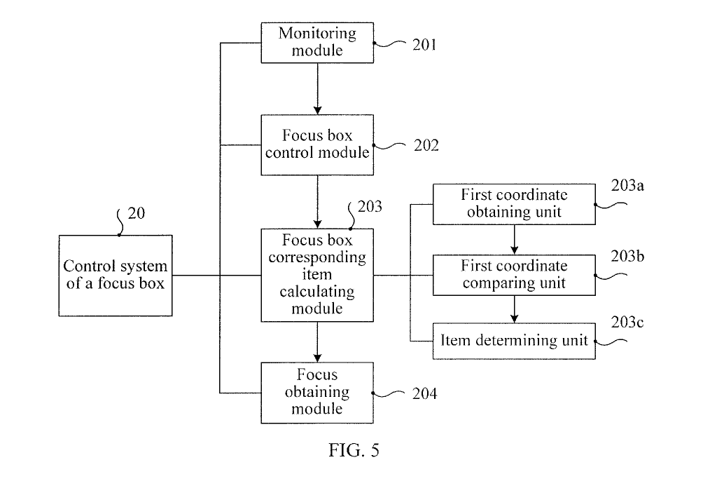

In another aspect, as shown in FIG. 5, an embodiments of the present disclosure further provides an apparatus for controlling a focus box, which includes:

a monitoring module 201 for monitoring slide events of a recycler view;

a focus box control module 202 for freezing a focus box in a current position when the monitoring module monitors the beginning of slide of the recycler view;

a focus box corresponding item calculating module 203 for calculating an item of the recycler view corresponding to the current position of the focus box when the monitoring module monitors the end of the slide; and

a focus obtaining module 204 for setting the item of the recycler view in the position covered by the focus box such that the item covered by the focus box obtains the focus.

In the embodiments of the present disclosure, the slide monitoring module 201 is set; the focus box has moved to the edge of a screen (on an item 4 shown in FIG. 1); a user presses a rightward selecting key and intends to select other items such as items 5, 6 and 7 (as shown in FIG. 2) in the recycler view; in this case, the monitoring module 201 monitors the beginning of the sliding of the recycler view, and the focus box control module 202 freezes the focus box in a current position; since the focus box is set on the upper layer of the recycler view, the recycler view continues to move; when the user releases the key, the recycler view stops sliding; the focus box corresponding item calculating module 203 calculates the item number under the focus box, for example, the sixth item, according to the position of the focus box, and the focus obtaining module 204 sets the item 6 of the recycler view in the position covered by the focus box such that the item 6 obtains the focus.

In other words, after the system transfers the focus according to the existing focus transferring rules (the focus is transferred to the fixed list item A or B from the fourth item of the recycler view when the rightward sliding key is continuously pressed), the focus box control module 202 transfers the focus once again to a control at which the focus should arrive (the calculated item of the recycler view corresponding to the current position of the focus box) according to a specific service scenario (for example, the RecyclerView continues to move in an AndroidUI system); in actual use, the focus box is used to store the position information of the item that should obtain the focus after sliding; afterward, the focus obtaining module 204 correctly recovers the focus according to the information, and the wrong focus search result of the system is given up; the final result that the focus box and the focus are on the same item is obtained, and misplacement and loss of the focus box is avoided.

Further, the focus box corresponding item calculating module 203 includes:

a first coordinate obtaining unit 203a for obtaining coordinates of four angles of the focus box and a coordinate of a center point of each item in the recycler view;

a first coordinate comparing unit 203b for performing containing judgment using the coordinates of the four angles of the focus box and the coordinate of the center point of each item in the recycler view; and

an item determining unit 203c for determining that, if a rectangle region formed by the coordinates of the four angles of the focus box contains a center point of an item in the recycler view, the item is the item of the recycler view corresponding to the current position of the focus box.

The size of the focus box is the same as that of an individual item of the recycler view. When the user releases the rightward selecting key, the recycler view stops sliding. The item of the recycler view displayed below the focus box may be some complete item or parts of two adjacent items. In the manner of performing containing judgment using the coordinates of the four angles of the focus box and the coordinate of a center point of each item in the recycler view through the coordinate comparing unit 203b, the item determining unit 203c selects the item with the center point in the focus box as the item corresponding to the current position of the focus box. Wrong selection of the focus when some contents of the two items are displayed in the focus box at the same time is avoided, and the item corresponding to the focus box is correctly selected.

In another embodiment of an apparatus 20 for controlling a focus box provided by the present disclosure, the focus box corresponding item calculating module 203 includes:

a second coordinate obtaining unit 203d for obtaining coordinates of four angles of the focus box and those of four angles of each item in the recycler view;

a second coordinate comparing unit 203e for comparing the coordinates of the four angles of the focus box with those of the four angles of each item in the recycler view respectively; and

a second item determining unit 203f for determining that, if coordinates of four angles of an item in the recycler view are the same as those of the four angles of the focus box, the item in the recycler view is the item of the recycler view corresponding to the focus box;

wherein the second item determining unit 203f is further configured for determining that an item in a slide direction is the item of the recycler view corresponding to the current position of the focus box when adjacent angle coordinates of two items simultaneously fall within the coordinate range of the four angles of the focus box.

After the item corresponding to the focus box is determined, the focus obtaining module 204 sets the corresponding item in the recycler view in the position covered by the focus box such that the item covered by the focus box obtains the focus. For example, as shown in FIG. 2, the recycler view slides left; when it stops sliding, two adjacent items 6 and 7 are displayed below the focus box; if it is calculated that the item of the recycler view corresponding to the current position of the focus box is item 6, the recycler view is required to slide right such that the item 6 completely enters the area covered by the focus box; at this point, blocking emerges visually, affecting the visual perception of the user.

The second coordinate comparing unit 203e compares the coordinates of the four angles of the focus box with those of four angles of each item in the recycler view respectively. When the second item determining unit 203f determines that adjacent angle coordinates of two items simultaneously fall within the coordinate range of the four angles of the focus box (the focus box displays partially two adjacent items 6 and 7), it is determined that an item in a slide direction is the item of the recycler view corresponding to the current position of the focus box, thereby improving visual smoothness and enhancing user experience.

Further, the focus box control module 203 is further configured for unfreezing the focus box on an item after the item obtains the focus, receiving a focus moving instruction, and moving the focus box in an instruction direction.

The focus box control module 203 is configured for disconnecting focus monitoring of the focus box and keeping the position of the focus box unchanged when the focus box needs freezing; and it is further configured for reconnecting the focus monitoring of the focus box and canceling the operation of keeping the position of the focus box unchanged when the focus box is unfrozen.

According to the method and apparatus for controlling a focus box provided by the embodiments of the present disclosure, the monitoring module 201 is provide; after the monitoring module monitors the beginning of the sliding of the recycler view, the focus box control module 202 freezes the focus box in the current position; when the user releases the key and the monitoring module 201 monitors the end of the sliding of the recycler view, the focus box corresponding item calculating module 203 calculates the item of the recycler view below the focus box according to the position of the focus box; the item is set in the position of the covered by the focus box and obtains the focus by the focus obtaining module 204; a final result that the focus box and the focus are on the same item is obtained, and the problem that the focus box is misplaced and the item newly sliding into the screen accidentally loses the focus when keeping on pressing the focus box selecting key is solved in a simple and effective way. Meanwhile, the second item determining unit 203f is arranged in the focus box corresponding item calculating module 203 and is configured for determining that the item of the recycler view is the item of the recycler view corresponding to the focus box if the coordinates of four angles of one of items in the recycler view are the same as those of the four angles of the focus box, thereby improving visual smoothness and enhancing user experience.

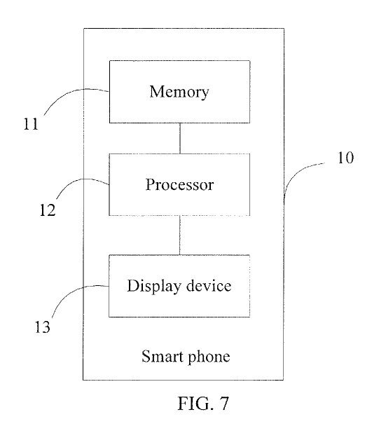

In another aspect, the present disclosure further provides a smart terminal. FIG. 7 shows the smart terminal 10 in an embodiment of the present disclosure.

As illustrated in FIG. 7, the smart terminal 10 includes: a memory 11, at least one processor 12, and a display device 13.

The memory 11 is configured for storing executable programs;

The at least one processor 12 is caused to execute the executable programs stored in the memory 11, thereby monitoring slide events of a recycler view, freezing a focus box in a current position when monitoring the beginning of slide of the recycler view, calculating an item of the recycler view corresponding to the current position of the focus box when monitoring the end of the slide, and setting the item of the recycler view in the position covered by the focus box such that the item covered by the focus box obtains a focus;

The display device 13 is configured for displaying a graphic user interface.

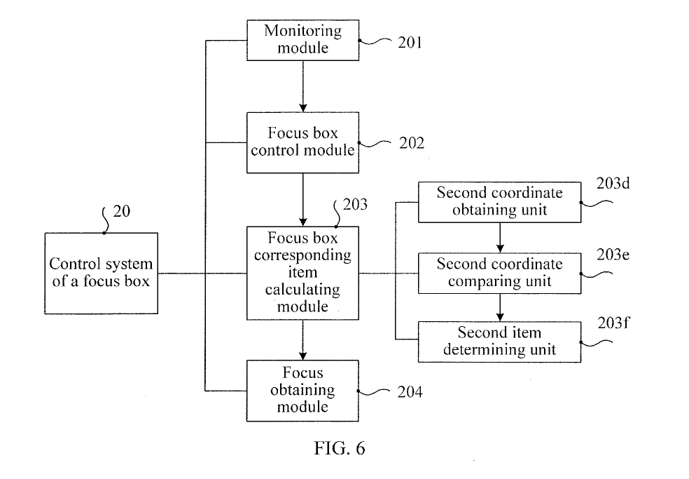

The memory 11 of the smart terminal 10 can be a non-transitory computer-readable memory medium, useful for storing a computer-executable instruction. When the instruction is processed by one or more central processing units, for example, it can make the central processing units to execute Steps 101-104 of FIG. 3 or Steps 101-105 of FIG. 4 or the functions of units 201-204 of FIGS. 5 and 6. The computer-executable instruction can also be stored and/or transmitted in any non-transitory computer-readable memory medium so that it can be used by an instruction executing system, device or apparatus, or be used in combination with an instruction executing system, device or apparatus, wherein the instruction executing system, device or apparatus includes a computer-based system, a processor-containing system, and other systems that can obtain an instruction from another instruction executing system, device or apparatus and execute the instruction. For the purpose of the present document, “non-transitory computer-readable memory medium” can be any medium that physically contains or stores a computer-executable instruction, which can be used by an instruction executing system, device or apparatus, or be used in combination with an instruction executing system, device or apparatus. The non-transitory computer-readable memory medium can include, but is not limited to, magnetic, optical, and/or semi-conductive memory medium. The examples of the memory medium include disk, optical disk based on CD, DVD or blue light technology, and persistent solid state memory (such as flash memory and solid state actuator).

The processor 12 can be a central processing unit (CPU for short). The processor 12 can also be other general processors, a digital signal processor (DSP), an application-specific integrated circuit (ASIC), a field programmable gate array (FPGA) or other programmable logic devices, discrete gate or transistor logic device, discrete hardware component, etc. The general processor can be a microprocessor or the processor can be any conventional processor.

Direct or indirect communications connection between the processor and the memory can be realized in any proper manner in the related art to accomplish data transmission, and it includes, but is not limited to, physical bus system connection and other invisible network connection. The bus system can include power bus, control bus, state signal bus, etc.

The smart terminal 10 provided in the embodiment solves the problem that the focus box is misplaced and the item newly sliding into the screen accidentally loses the focus when keeping on pressing the focus box selecting key in a simple and effective way.

Moreover, the focus box corresponding item calculating module includes a second item determining unit for determining that the item in the sliding direction is the item of the recycler view corresponding to the current position of the focus box when adjacent angle coordinates of two items simultaneously fall within the coordinate range of the four angles of the focus box, thereby improving visual smoothness and enhancing user experience.

Those ordinary skilled in the art should realize: the units and algorithm steps in each example described in the embodiments disclosed in the present application can be performed by electronic hardware, computer software or a combination thereof. To clarify the interchangeability of hardware and software, the constitution and steps in each example have been generally described in the above explanations according to functions. Whether these function are executed by hardware or software depends on the specific applications of the technical solution and the design constraint conditions. As for each specific application, those ordinary skilled in the art can achieve the described functions in different methods, but the achievement should not be deemed to go beyond the scope of the present disclosure. The computer software can be stored in the computer-readable memory medium. During execution, the program can include the flow of the embodiments of the above methods. The memory medium can be disk, optical disk, read-only memory, random memory, and so on.

Those ordinary skilled in the art should understand: the discussion on any of the above embodiments is merely exemplary, without intention to imply that the scope of the present disclosure (including the claims) is limited to those embodiments; consistent with the thought of the present disclosure, combinations of the technical features in one or more of the above embodiments are feasible, and many other changes in different aspects of the present disclosure exist; for conciseness, these combinations and changes are not presented in details. Therefore, any omission, modification, equivalent replacement, improvements among others within the spirit and principle of the present disclosure should be contained within the protection scope of the present disclosure.

What is claimed is:

1. A method for controlling a focus box, comprising:
at an electronic device;
monitoring slide events of a recycler view;
freezing the focus box in a current position when monitoring a beginning of slide of the recycler view;
calculating an item of the recycler view corresponding to the current position of the focus box when monitoring an end of the slide; and
setting the item of the recycler view in the position covered by the focus box such that the item covered by the focus box obtains a focus.

2. The method according to claim 1, wherein calculating an item of the recycler view corresponding to the current position of the focus box comprises:
obtaining coordinates of four angles of the focus box and a coordinate of a center point of each item in the recycler view;
performing containing judgment using the coordinates of the four angles of the focus box and the coordinate of the center point of each item in the recycler view; and
determining that, if a rectangle region formed by the coordinates of the four angles of the focus box contains a center point of an item in the recycler view, the item is the item of the recycler view corresponding to the current position of the focus box.

3. The method according to claim 1, wherein calculating an item of the recycler view corresponding to the current position of the focus box comprises:
obtaining coordinates of four angles of the focus box and coordinates of four angles of each item in the recycler view,
comparing the coordinates of the four angles of the focus box with the coordinates of the four angles of each item in the recycler view respectively;
determining that, if coordinates of four angles of an item in the recycler view are the same as the coordinates of the four angles of the focus box, the item in the recycler view is the item of the recycler view corresponding to the focus box; and
determining that an item in a slide direction is the item of the recycler view corresponding to the current position of the focus box when adjacent angle coordinates of two items simultaneously fall within a coordinate range of the four angles of the focus box.

4. The method according to claim 1, further comprising:
unfreezing the focus box;
receiving a focus moving instruction; and
moving the focus box in an instruction direction.

5. The method according to claim 4, wherein unfreezing the focus box comprises: reconnecting the focus monitoring of the focus box and canceling the operation of keeping the position of the focus box unchanged;
wherein freezing a focus box in a current position comprises:
disconnecting focus monitoring of the focus box; and
keeping the position of the focus box unchanged.

6. An electronic device, comprising:
at least one processor; and
a memory communicably connected with the at least one processor for storing instructions executable by the at least one processor, wherein execution of the instructions by the at least one processor causes the at least one processor to:
monitor slide events of a recycler view;
freeze the focus box in a current position when monitoring a beginning of slide of the recycler view;
calculate an item of the recycler view corresponding to the current position of the focus box when monitoring an end of the slide; and
set the item of the recycler view in the position covered by the focus box such that the item covered by the focus box obtains a focus.

7. The electronic device according to claim 6, wherein calculating an item of the recycler view corresponding to the current position of the focus box comprises:
obtaining coordinates of four angles of the focus box and a coordinate of a center point of each item in the recycler view;
performing containing judgment using the coordinates of the four angles of the focus box and the coordinate of the center point of each item in the recycler view; and
determining that, if a rectangle region formed by the coordinates of the four angles of the focus box contains a center point of an item in the recycler view, the item is the item of the recycler view corresponding to the current position of the focus box.

8. The electronic device according to claim 6, wherein calculating an item of the recycler view corresponding to the current position of the focus box comprises:
obtaining coordinates of four angles of the focus box and coordinates of four angles of each item in the recycler view;
comparing the coordinates of the four angles of the focus box with the coordinates of the four angles of each item in the recycler view respectively;
determining that, if coordinates of four angles of an item in the recycler view are the same as the coordinates of the four angles of the focus box, the item in the recycler view is the item of the recycler view corresponding to the focus box; and
determining that an item in a slide direction is the item of the recycler view corresponding to the current position of the focus box when adjacent angle coordinates of two items simultaneously fall within a coordinate range of the four angles of the focus box.

9. The electronic device according to claim 6, wherein execution of the instructions by the at least one processor further causes the at least one processor to:
unfreeze the focus box;
receive a focus moving instruction; and
move the focus box in an instruction direction.

10. The electronic device according to claim 9, wherein unfreezing the focus box comprises:
reconnecting the focus monitoring of the focus box and canceling the operation of keeping the position of the focus box unchanged;
wherein freezing a focus box in a current position comprises:
disconnecting focus monitoring of the focus box; and
keeping the position of the focus box unchanged.

11. A non-transitory computer-readable storage medium storing executable instructions, wherein when executed by an electronic device, causes the electronic device to:
monitor slide events of a recycler view;
freeze the focus box in a current position when monitoring a beginning of slide of the recycler view;
calculate an item of the recycler view corresponding to the current position of the focus box when monitoring an end of the slide; and
set the item of the recycler view in the position covered by the focus box such that the item covered by the focus box obtains a focus.

12. The non-transitory computer-readable storage medium according to claim 11, wherein calculating an item of the recycler view corresponding to the current position of the focus box comprises:
obtaining coordinates of four angles of the focus box and a coordinate of a center point of each item in the recycler view;
performing containing judgment using the coordinates of the four angles of the focus box and the coordinate of the center point of each item in the recycler view; and
determining that, if a rectangle region formed by the coordinates of the four angles of the focus box contains a center point of an item in the recycler view, the item is the item of the recycler view corresponding to the current position of the focus box.

13. The non-transitory computer-readable storage medium according to claim 12, wherein calculating an item of the recycler view corresponding to the current position of the focus box comprises:
obtaining coordinates of four angles of the focus box and coordinates of four angles of each item in the recycler view;
comparing the coordinates of the four angles of the focus box with the coordinates of the four angles of each item in the recycler view respectively;
determining that, if coordinates of four angles of an item in the recycler view are the same as the coordinates of the four angles of the focus box, the item in the recycler view is the item of the recycler view corresponding to the focus box; and
determining that an item in a slide direction is the item of the recycler view corresponding to the current position of the focus box when adjacent angle coordinates of two items simultaneously fall within a coordinate range of the four angles of the focus box.

14. The non-transitory computer-readable storage medium according to claim 12, wherein when the executable instructions are executed by the electronic device, further causes the electronic device to:
unfreeze the focus box;
receive a focus moving instruction; and
move the focus box in an instruction direction.

15. The non-transitory computer-readable storage medium according to claim 14, wherein unfreezing the focus box comprises: reconnecting the focus monitoring of the focus box and canceling the operation of keeping the position of the focus box unchanged;
wherein freezing a focus box in a current position comprises:
disconnecting focus monitoring of the focus box; and
keeping the position of the focus box unchanged.
